(19) United States
(12) Patent Application Publication
(10) Pub. No.: US 2004/0117308 A1
(43) Pub. Date: Jun. 17, 2004

(54) Instant, physiologically-based execution of customer-oriented transactions

(75) Inventor: Wendell J. Bouknight JR., Raleigh, NC (US)

Correspondence Address: Jeanine S. Ray-Yarletts, IBM Corporation T81/503, PO Box 12195, Research Triangle Park, NC, 27709, US

(73) Assignee: International Business Machines Corporation, Armonk, NY

(21) Appl. No.: 10/317,430

(22) Filed: Dec. 12, 2002

(51) Int. Cl. G06F 17/60

(52) U.S. Cl. 705/44

(57) ABSTRACT

A user defines a transaction (or, equivalently, a sequence of operations) and registers that transaction in association with unique, user-specific physiological identification (such as the user's fingerprint or retinal scan). When the user subsequently presents the physiological identification, the registered transaction is executed instantly and automatically, without requiring any further user input. Therefore, the user does not have to carry additional authentication media (such as an automated teller machine card issued by the bank) or remember additional information (such as personal identification numbers) to be able to perform transactions.

### BACKGROUND OF THE INVENTION

1. Field of the Invention

The present invention relates to a computer system, and deals more particularly with methods, systems, computer program products, and methods of doing business whereby a user can carry out transactions (such as banking transactions) instantly and automatically through use of physiologically-based identification.

2. Description of the Related Art

People today engage in many customer-oriented transactions, some of which involve interactions with other people and others that involve interactions with automated processes. For example, to perform banking transactions, bank customers primarily interact with a banking entity in one of the following three ways:

branch banking: the customer interacts with a human teller or other associate

automated teller machine (“ATM”): the customer accesses a kiosk which can be positioned in numerous locations (such as malls, grocery stores, etc.)

on-line banking: the customer uses a personal computer as a front-end for performing transactions

In each of these cases, the customer must perform the following steps:

(1) authenticate: produce identification which must be validated, such as an ATM card, a picture identification (“ID”), a personal identification number (“PIN”), etc.; and

(2) make a decision: select a transaction to perform, such as “withdraw $40 from my checking account”.

Identifying the customer can be done with many different physiological identifiers, such as a fingerprint or palm print, voice recognition, a retinal scan, or with non-physiological identifiers, such as the previously-mentioned ATM card or picture ID, or perhaps a so-called “smart card”. These types of physiological identifiers are unique to each person, and therefore they inherently identify the person. The non-physiological identifiers, on the other hand, do not inherently identify a single person, and therefore additional validation is required when using such identifiers. In either case, the process of conclusively determining whether the person is who he purports to be is commonly referred to as “authenticating” the person. (The terms “person”, “user”, and “customer” are used interchangeably herein.)

Once the user is authenticated, he may select from a number of available transaction types. Selecting the transaction to perform is not a difficult task, but it can become very repetitive. The customer must execute at least one action. In a branch bank, for example, the customer might simply speak to the teller, or when using an ATM, the customer might push a button.

It is believed that people have a propensity for executing the same transaction when engaging a banking entity multiple times. For example, a customer “Bob” might be in the habit of withdrawing $100 from his checking account when he stops at the ATM after work every Monday. A non-scientific survey of a small number of volunteers demonstrated that people who prefer an ATM for banking transactions chose the same transaction almost 2 out of 3 times (64 percent), and those who walked into a branch bank were likely to choose the same transaction nearly 9 out of 10 times (88 percent). Furthermore, the survey showed that a majority of those polled preferred an ATM (56 percent) as opposed to other options (44 percent).

What is needed are techniques for making these types of repetitive transactions faster and more convenient, while ensuring that sufficient security measures are in place.

### SUMMARY OF THE INVENTION

An object of the present invention is to make repetitive transactions faster and more convenient for users.

Another object of the present invention is to execute repetitive transactions instantly and automatically, upon presentation by the user of physiological identification.

A further object of the present invention is to provide automated customer-oriented transactions while ensuring that sufficient security measures are in place for those transactions.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for instantly and automatically executing a transaction. In one aspect of preferred embodiments, this technique comprises: creating a unique association between user-specific biometric data and a particular transaction; and responsive to presentment of the user-specific biometric data, instantly and automatically executing the particular transaction. Creating the unique association preferably further comprises: registering, for a user, unique user-specific biometric data; defining, for the user, a particular transaction to be associated with the registered biometric data; and storing an association between the registered biometric data and the defined transaction. Executing the particular transaction preferably further comprises: detecting that the user-specific biometric data has been presented; and accessing the unique association between the biometric data and the particular transaction, thereby identifying the particular transaction to be executed. Optionally, a confirmation of success or failure of the executed transaction may be provided. When the transaction is defined, all required parameter values are preferably defined (which may include an iterative approach of providing values and validating those values, until correct values are defined for all required parameters).

In another aspect of preferred embodiments, the technique comprises instantly and automatically executing transactions by detecting that a user has presented user-specific biometric data, accessing a stored association where the user-specific biometric data uniquely identifies a particular transaction, and instantly and automatically executing the particular transaction. The transaction may be, for example, a banking transaction and the user-specific biometric data may be one of: a fingerprint, a palm print, a voice print, a retinal scan, or skin-chemistry input.

More than one association may be stored for some of the users, each of the associations having different types of biometric data. In this case, a different transaction is preferably identified by each of the user's different types of biometric data.

The present invention may also be practiced by registering, for a user, unique user-specific biometric data; defining, for the user, a particular transaction to be associated with the registered biometric data; storing a unique association between the registered biometric data and the defined transaction; detecting that the user-specific biometric data has been presented; accessing the unique association between the biometric data and the particular transaction, thereby identifying the particular transaction to be executed; and instantly and automatically executing the identified transaction. The registering, defining, and storing may be repeatedly operated to register, define, and store biometric data and associated transactions for a plurality of users. In this case, the detecting operation detects user-specific biometric data of a selected one of the plurality of users, and the accessing operation identifies the particular transaction to be executed for the selected user.

The present invention may also be used advantageously in methods of doing business. For example, a business may provide its customer the opportunity to register particular transactions in association with selected physiological identification mechanisms. The business may optionally charge a fee for the registration process, and/or a fee for executing the registered transactions (such as a pay-per-use charge or a periodic subscription fee).

The present invention will now be described with reference to the following drawings, in which like reference numbers denote the same element throughout.

### BRIEF DESCRIPTION OF THE DRAWINGS

FIG. 1 depicts a set-up phase for using preferred embodiments of the present invention; and

FIG. 2 depicts a typical usage scenario for using preferred embodiments.

### DESCRIPTION OF PREFERRED EMBODIMENTS

The present invention simplifies the process of executing highly-important customer-oriented transactions automatically and more securely (particularly in a banking environment) than traditional approaches. A predefined transaction is associated with a user's physiological identification, and when that identification is presented, the transaction is executed instantly and automatically. Therefore, when using the present invention, the user does not have to carry additional authentication media (such as an ATM card issued by the bank) or remember additional information (such as PINs) to be able to perform transactions. (A possible exception is an automatic identifier, such as a “Radio Frequency Identification” or “RFID” signal transmitter, which the user might carry for the sole purpose of increasing security for all interested parties—i.e., the bank and customer. An RFID signal transmitter may be used to uniquely identify a person, much like a personal “bar code”. Even in this case, however, the user is not required to perform any additional action, since the signal is already being automatically transmitted.)

If a user is robbed of his ATM card, he is unable to obtain money from an ATM according to prior art approaches. Because the present invention does not require the user to carry this type of authentication media, however, the user can still obtain money (if that is the transaction he previously defined).

The repetitive execution of a transaction is made faster and more convenient when using techniques disclosed herein. Furthermore, because the transaction occurs instantly and automatically, it is therefore less tedious and less error-prone than when using prior art techniques (where the repetitive nature may cause the user to become inattentive and overlook details of what he is doing).

An entity that implements an embodiment of the present invention gains an immediate efficiency boost, because transactions are able to be executed with less latency as a result of user actions. That is, users will not hold up the line at an ATM while they struggle to key in their PIN correctly, customers in the teller line will not need to search for their photo ID, users executing transactions through on-line banking will not have time to get distracted part way through the steps of specifying their desired transaction parameters, and so forth.

Security of the automatic transactions is improved over prior art techniques that use non-physiological identification. A customer's PIN might be stolen in the prior art, or simply guessed, allowing a thief to use the customer's ATM card and withdraw the customer's money. Embodiments of the present invention avoid this exposure by using physiological identification (referred to equivalently herein as “biometric information”), which cannot be faked by an impostor.

Techniques for biometric identification are known in the art, and devices which enable this type of identification are commercially available. Biometric sensors exist that analyze a person's fingerprint, palm print, voice print, retinal scan, or skin chemistry. To authenticate a user in this manner, the user provides his biometric input through the appropriate biometric sensor. Previously-stored information for this user is then accessed from a storage repository and compared to the just-received information using complex analytical formulas. Preferred embodiments leverage these existing techniques for user authentication.

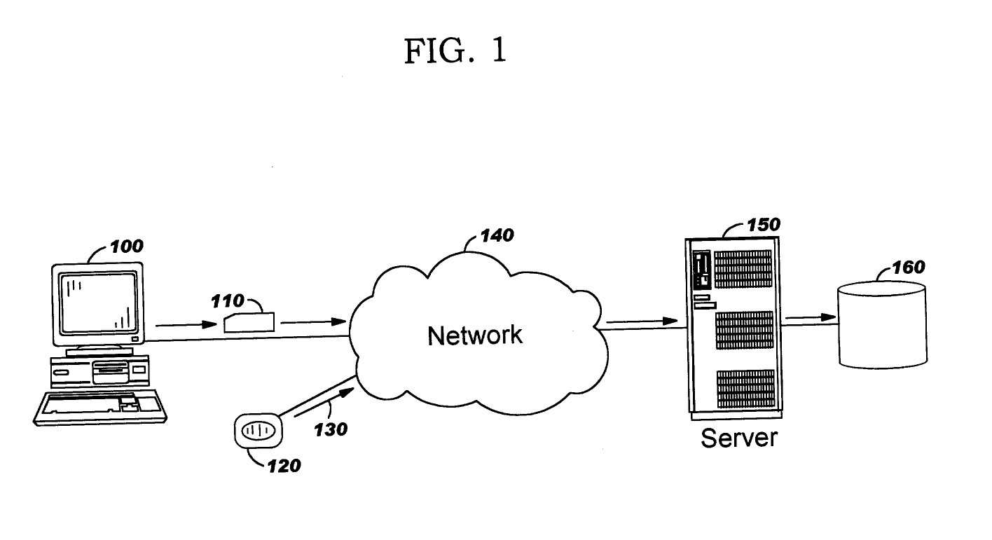

Referring now to FIG. 1, a set-up phase is illustrated. For ease of reference, a banking example is used, although the techniques disclosed herein apply equally to transactions with other types of entities.

A user “Bob” defines a particular transaction, for example by accessing a graphical user interface (“GUI”) of a computer workstation 100. According to preferred embodiments, all required parameters are defined at this time, including the particular type of transaction, the corresponding account number(s), the transaction amount, and so forth. Preferably, the bank at which the transaction will be processed provides a transaction configuration interface that requests the appropriate parameters for each transaction type and validates those parameters for correctness (such as making sure that all digits of the user's account number are correct, and so forth). This may be an iterative process, whereby one or more messages 110 are exchanged over a communications network 140 via a communication session between the user's workstation 100 (or, alternatively, a workstation provided at the bank or elsewhere) and an application executing on a server or other computing device 150. The particular manner in which the transaction is defined may vary from one implementation of the invention to another.

Once the parameters have been completely defined, the user's transaction information is stored in persistent storage at a repository 160. For example, Bob might specify that his transaction is “withdraw $40 from checking account 123456, using $10 bills if available otherwise using $20 bills”; another user Mary might specify that her transaction is “transfer $2000 from my savings account 111222 to my mortgage loan account 333444”.

The user must also register his unique physiologically-based identifier with the bank. A previously-captured physiologically-based identifier may be used, if available (for example, when the user wishes to redefine the transaction associated with his stored identifier). Or, the user may provide biometric data through a sensor, depicted in FIG. 1 at element 120. In this case, the captured physiologically-based identifying information is sent 130 through the network 140, and the receiver stores it in persistent storage. (Preferably, the same persistent storage repository is used for both the transactions and the biometric data, in order to optimize subsequent lookup operations. However, different storage repositories may be used without deviating from the scope of the present invention.)

As will be obvious, the particular way in which the user's identifying information is captured and transmitted will vary, depending on the type of data and corresponding sensor. For example, if a voice print is used, a microphone may be provided to receive the input, and that input may be recorded as a “.wav” (i.e., audio) file. On the other hand, if a fingerprint is used, a recording device for the print must be provided, and the input may be recorded (for example) as a “.jpg” or “.bmp” (i.e., image) file. Techniques for capturing, recording, and transmitting biometric information are known in the art, and a detailed discussion thereof is not deemed essential to an understanding of the present invention.

An association is created between the user's biometric data and his defined transaction. This may be done in a number of ways, such as storing pointers from one record to the other; storing record addresses in a lookup table; defining entries in a directory; and so forth. In one embodiment, the biometric data and transaction definition are stored in the same record. (The term “record” is used herein to refer to a data structure, but is not meant to imply any particular type of structure and is not meant to exclude use of objects in object-oriented programming environments.)

The set-up phase is then complete for this transaction. Note that a particular user may define more than one transaction; in preferred embodiments, a separate physiologically-based identifier is associated with each defined transaction. Thus, a practical limitation on the number of concurrently-defined transactions is the number of unique biometric sensors supported by the user's bank.

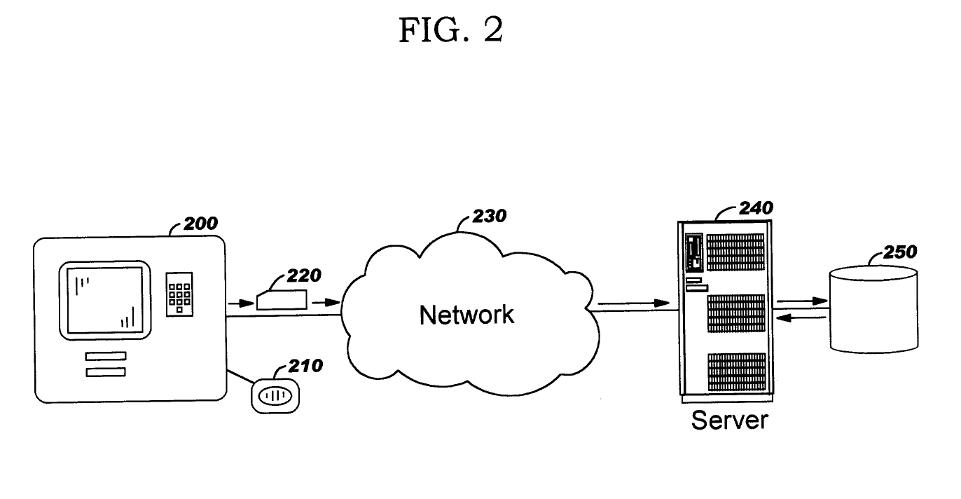

FIG. 2 illustrates a typical usage scenario for embodiments of the present invention. The user selects an ATM 200 or other appropriate kiosk or device that has a suitable operably-connected biometric sensor 210. The user provides input to the sensor, and this input is transmitted 220 via a communications network 230 for lookup 250 by an application 240 (which may be the same software, or different software, than used for the setup phase).

According to preferred embodiments, the user's biometric data uniquely identifies a single transaction. Therefore, once the lookup operation locates the transaction, it is instantly and automatically performed. No explicit actions are required by the user, other than supplying the biometric input data to sensor 210. Thus, if the user's defined transaction is to dispense money from an ATM, then the money is dispensed nearly immediately, with no requirement to insert a card, press buttons, specify account numbers, confirm selections, and so forth. Optionally, a confirmation of the transaction's success or failure (e.g., a printed receipt, e-mail message, spoken confirmation, etc.) may be relayed to the user. In one aspect, the user chooses whether to receive a confirmation, and this choice is registered as part of the transaction parameters.

As has been demonstrated, the present invention provides advantageous techniques for executing transactions very quickly and conveniently, automatically carrying out a registered transaction once the user has been recognized. (While the term “transaction” is used herein, it is intended in the generic sense to represent a sequence of operations, without regard to a specific purpose of those operations. Techniques of the present invention may be used advantageously in any scenario that involves the act of transacting within or between groups, as in the case of carrying on commercial activities.)

The techniques disclosed herein may also be used to provide improved methods of doing business. Entities allowing their customers to use instant, physiologically-based transaction execution can reduce the associated transaction time, thereby allowing them to serve more customers as well serving each customer more quickly and efficiently. The customers benefit from the increased convenience and accuracy of the transactions, as well as from the reduced transaction time.

Commonly-assigned U.S. patent application Ser. No. ______ (Ser. No. 09/764,844, filed on Jan. 17, 2001), entitled “Smart Card with Integrated Biometric Sensor”, discloses a smart card that has a biometric sensor embedded within the surface of the card. Using this integrated card avoids security exposures that exist when a user must provide a PIN in conjunction with his smart card. As discussed earlier, embodiments of the present invention obviate the need for users to carry a smart card or other authenticating media. Commonly-assigned U.S. patent application Ser. No. ______(Ser. No. 09/764,827, also filed on Jan. 17, 2001), entitled “Technique for Continuous User Authentication”, discloses techniques for continuously authenticating a user for the duration of a transaction. Thus, even though a criminal might interrupt an in-process ATM transaction or knock out a person who is in the midst of an on-line transaction at his computer, the transaction cannot be completed when the user ceases providing his authenticating information. As disclosed therein, continuous biometric authentication is used, whereby a device equipped with a biometric sensor repeatedly checks the user's identity. A security function monitors the biometric sensor and cancels the transaction in the event of any interruption in the user's biometric authentication. The instantaneous nature of executing transactions when using the present invention eliminates this concern.

An application has been demonstrated using the Host On-Demand product from the International Business Machines Corporation whereby a user's smart card is read, logging the user onto a client workstation and then launching a terminal emulator that connects to a specific host application. However, this is distinct from the present invention in several ways. Rather than preprogrammed screen navigation, the present invention is directed toward carrying out customer-oriented transactions. In the demonstrated application, the user is assisted by performing multiple steps, but ultimately the user is still required to provide additional interactions (i.e., with the emulator and host application), whereas the present invention provides for executing a complete transaction, after which the user may go about his other business. In addition, smart cards of the prior art require additional authenticating information, such as a PIN, to ensure that the person possessing the smart card is the legitimate owner. The present invention does not require additional authenticating information or additional media such as cards.

As will be appreciated by one of skill in the art, embodiments of the present invention may be provided as methods, systems, or computer program products. Accordingly, the present invention may take the form of an entirely hardware embodiment, an entirely software embodiment, or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

While the preferred embodiments of the present invention have been described, additional variations and modifications in those embodiments may occur to those skilled in the art once they learn of the basic inventive concepts. Therefore, it is intended that the appended claims shall be construed to include both the preferred embodiment and all such variations and modifications as fall within the spirit and scope of the invention.

What is claimed is:

1. A method of instantly and automatically executing transactions, comprising steps of:
creating a unique association between user-specific biometric data and a particular transaction; and
responsive to presentment of the user-specific biometric data, instantly and automatically executing the particular transaction.

2. The method according to claim 1, wherein the creating step further comprises the steps of:
registering, for a user, unique user-specific biometric data;
defining, for the user, a particular transaction to be associated with the registered biometric data; and
storing an association between the registered biometric data and the defined transaction.

3. The method according to claim 1, wherein the executing step further comprises the steps of:
detecting that the user-specific biometric data has been presented; and
accessing the unique association between the biometric data and the particular transaction, thereby identifying the particular transaction to be executed.

4. The method according to claim 1, further comprising the step of providing a confirmation of success or failure of the executed transaction.

5. The method according to claim 2, wherein the defining step further comprises the step of defining all required parameter values for the particular transaction.

6. The method according to claim 2, wherein the defining step further comprises the steps of:
providing, by the user, parameter values for the particular transaction;
validating the provided values; and
repeating operation of the providing and validating steps until correct values are defined for all required parameters.

7. A method of instantly and automatically executing transactions, comprising steps of:
detecting that a user has presented user-specific biometric data;
accessing a stored association where the user-specific biometric data uniquely identifies a particular transaction; and
instantly and automatically executing the particular transaction.

8. The method according to claim 7, wherein the transaction is a banking transaction.

9. The method according to claim 7, wherein the user-specific biometric data is one of: a fingerprint, a palm print, a voice print, a retinal scan, or skin-chemistry input.

10. The method according to claim 7, wherein more than one association is stored for the user, each of the associations having different types of biometric data, and wherein a different transaction is identified by each of the user's different types of biometric data.

11. A system for instantly and automatically executing transactions, comprising:
means for registering, for a user, unique user-specific biometric data;
means for defining, for the user, a particular transaction to be associated with the registered biometric data;
means for storing a unique association between the registered biometric data and the defined transaction;
means for detecting that the user-specific biometric data has been presented;
means for accessing the unique association between the biometric data and the particular transaction, thereby identifying the particular transaction to be executed; and
means for instantly and automatically executing the identified transaction.

12. The system according to claim 11, wherein:
the means for registering, means for defining, and means for storing are repeatedly operated to register, define, and store biometric data and associated transactions for a plurality of users;
the means for detecting detects user-specific biometric data of a selected one of the plurality of users; and
the means for accessing identifies the particular transaction to be executed for the selected user.

13. A computer program product for instantly and automatically executing transactions, the computer program product embodied on one or more computer-usable media and comprising:
computer-readable program code means for detecting that a user has presented user-specific biometric data;
computer-readable program code means for accessing a stored association where the user-specific biometric data uniquely identifies a particular transaction; and
computer-readable program code means for instantly and automatically executing the particular transaction.

14. The computer program product according to claim 13, further comprising computer-readable program code means for providing confirmation of success or failure of the executed transaction.

15. A method of doing business by providing instant, physiologically-based customer-oriented transactions, further comprising steps of:
allowing users to register unique user-specific biometric data;
allowing users to define a particular transaction to be associated with each of the registered biometric data;
storing a unique association between the registered biometric data and the defined transaction for each user;
detecting that the user-specific biometric data for a selected user has been presented;
accessing the stored unique associations, thereby identifying the particular transaction to be executed for the selected user; and
instantly and automatically executing the identified transaction.

16. The method according to claim 15, further comprising the step of charging a fee for the registration.

17. The method according to claim 15, further comprising the step of charging a fee for executing the identified transaction.
